(19) United States
(12) Patent Application Publication
(10) Pub. No.: US 2024/0013285 A1
(43) Pub. Date: Jan. 11, 2024

(54) METHOD, SERVER, AND USER TERMINAL FOR PROVIDING GIFT INFORMATION

(71) Applicant: KAKAO CORP., Jeju-si (KR)

(72) Inventors: Ji Hye PARK, Seongnam-si (KR); Hee Jin KIM, Seongnam-si (KR); Lim Ah LEE, Seongnam-si (KR); Je Woo SONG, Seongnam-si (KR); In Young JEONG, Seongnam-si (KR)

(21) Appl. No.: 18/343,572

(22) Filed: Jun. 28, 2023

(30) Foreign Application Priority Data
Jul. 5, 2022 (KR) 10-2022-0082793

(51) Int. Cl. G06Q 30/0601

(52) U.S. Cl. CPC G06Q 30/0635

(57) ABSTRACT

A method of providing gift information by a server is proposed. The method may include receiving from a second user a gift provision request for sending a gift to a first user, and generating gift information in response to the gift provision request. The method may also include determining whether the second user is a blocked friend set by the first. The method may further include in response to determining that the second user is the blocked friend, providing the first user with blinded gift information corresponding to the gift information, wherein partial information out of the gift information is not shown in the blinded gift information. The method may further include in response to receiving an unblind request for the blinded gift information from the first user, providing the first user with the partial information out of the gift information.

### CROSS-REFERENCE TO RELATED APPLICATION

This application claims priority to and the benefit of Korean Patent Application No. 10-2022-0082793 filed on Jul. 5, 2022, the disclosure of which is incorporated herein by reference in its entirety.

### BACKGROUND

### Technical Field

The present disclosure relates to a method for providing gift information by a server, a server performing the same, a method for displaying gift information by a user terminal, and a user terminal performing the same.

### Description of Related Technology

Messenger services provided through smartphones, tablets, computers, and PCs are widely used.

### SUMMARY

An objective of the present disclosure is to provide a method for providing gift information from a blocked friend set by a user, so that part of the gift information is blinded and thus unwanted information is exposed to the user.

In addition, another objective of the present disclosure is to provide the user with the right to unblind the gift information partially blind, so that the user can check the information by his or her own choice and decide whether to receive the gift.

In one aspect, there is provided a method for providing gift information by a server, the method including: receiving from a second user a gift provision request for sending a gift to a first user; generating gift information in response to the gift provision request; determining whether the second user is a blocked friend set by the first; in response to determining that the second user is the blocked friend, providing the first user with blinded gift information corresponding to the gift information, wherein partial information out of the gift information is not shown in the blinded gift information; and in response to receiving an unblind request for the blinded gift information from the first user, providing the first user with the partial information out of the gift information.

According to an embodiment of the present disclosure, the method may further include in response to receiving a delete request for the blinded gift information from the first user, changing the gift information to a deleted state.

According to an embodiment of the present disclosure, the method may further include providing the first user with information on an unblinding available period for the blinded gift information; and in response to failing to receive the unblind request and the delete request from the first user within the unblinding available period, changing the gift information to a cancelled state.

According to an embodiment of the present disclosure, the partial information out of the gift information may include at least one of sender information and gift details in the gift information.

According to an embodiment of the present disclosure, the method may further include: in response to determining that the second user is the blocked friend, setting state information on the gift information to a blinded state; and in response to receiving an unblind request for the blinded gift information from the first user, changing the state information from the blinded state to an unblinded state.

According to an embodiment of the present disclosure, the method may further include: providing information on an unblinding available period for the blinded gift information; and in response to receiving a delete request for the blinded gift information from the first user or failing to receive any of an unblind request and a delete request from the first user within the unblinding available period, changing the state information from the blinded state to the deleted state.

According to an embodiment of the present disclosure, the method may further include: in response to receiving a request for the state information from the first user, providing the state information to the first user.

According to an embodiment of the present disclosure, the method may further include: in response to receiving a request to provide the partial information out of the gift information from the first user before receiving the unblind request or the delete request, providing the first user with the partial information out of the gift information.

According to an embodiment of the present disclosure, the method may further include: in response to determining that the second user is the blocked friend, setting state information on the gift information to a blinded state; in response to receiving from the first user a request to provide the partial information out of the gift information; and in response to receiving an unblind request for the blinded gift information from the first user, changing the state information from the blinded state to an unblinded state.

According to an embodiment of the present disclosure, the method may further include: in response to receiving a request to delete the blinded gift information from the first user, providing the second user with decline information of the first user in response to the gift provision request.

According to an embodiment of the present disclosure, the method may further include: providing information on an unblinding available period for the blinded gift information, and in response to receiving the unblind request and the delete request from the first user within the unblinding available period, providing the second user with decline information of the first user for the gift provision request.

According to one embodiment of the present disclosure, the gift provision request may include information on a shipping address of the gift, and the method may further include, in response to receiving a request to delete the blinded gift information from the first user, providing the second user with cancellation information due to the first user's failing to input shipping address information for the gift provision request.

In another aspect, there is provided a server for providing gift information, the server including: a memory; and a processor connected to the memory and configured to execute instructions stored in the memory. The processor is further configured to: receive from the second user a gift provision request for sending a gift to the first user; generate gift information in response to the gift provision request; determine whether the second user is a blocked friend set by the first user; in response to determining that the second user is the blocked friend, provide the first user with blinded gift information corresponding to the gift information, wherein partial information out of the gift information is not shown in the blinded gift information; and in response to receiving an unblind request for the blinded gift information from the first user, provide the first user with the partial information out of the gift information.

In yet another aspect, there is provided a method for displaying gift information by a user terminal, the method including: displaying blinded gift information, wherein partial information out of the gift information is not shown in the blinded gift information; providing an unblind request interface and a delete request interface for the blinded gift information; and in response to receiving an unblind request interaction to the unblind request interface, changing the blinded gift information to general gift information, wherein the partial information out of the generation information is additionally displayed in the blinded gift information.

According to an embodiment of the present disclosure, the method may further include: in response to receiving a delete request interaction to the delete request interface, changing the blinded gift information to deleted gift information.

According to an embodiment of the present disclosure, the method may further include: displaying information on an unblinding available period for the blinded gift information; and in response to failing to receiving the unblind request interaction and the delete request interaction within the unblinding available period, changing the blinded gift information to deleted gift information.

According to an embodiment of the present disclosure, the partial information out of the gift information may include at least one of sender information and gift details in the gift information.

According to an embodiment of the present disclosure, the method may further include: providing a blind information check interface for the blinded gift information; and in response to receiving a blind information check interaction to the blind information check interface, displaying partial information out of the blinded gift information while maintaining the blinded gift information in a blinded state.

According to an embodiment of the present disclosure, the method may further include: receiving gift information sent by other party; determining whether the other party is a blocked friend set by the user; in response to determining that the other party is the blocked friend, setting the gift information as the blinded gift information; and in response to determining that the other party is not the blocked friend, setting the gift information as the general gift information.

In yet another embodiment, there is provided a server for providing gift information, the server including: a memory; and a processor connected to the memory and configured to execute instructions stored in the memory. The processor is further configured to: display blinded gift information, wherein the blinded gift information does not show partial information out of the gift information; provide an unblind request interface and a delete request interface for the blinded gift information; and in response to receiving the unblind request interaction to the unblind request interface, change the blinded gift information to general gift information, wherein the general gift information additionally shows the partial information in the blinded gift information.

### BRIEF DESCRIPTION OF THE DRAWINGS

FIG. 1 is a diagram showing an example of a network environment of the present disclosure.

FIG. 2 is a flowchart illustrating a method of providing gift information according to an embodiment of the present disclosure.

FIG. 3 is a diagram for explaining a database for gift information according to an embodiment of the present disclosure.

FIGS. 4 to 10 illustrate examples of screens displayed in a user terminal in a process of performing a method of providing gift information according to an embodiment of the present disclosure.

FIGS. 11 and 12 are diagrams for explaining a method of displaying gift information according to an embodiment of the present disclosure.

### DETAILED DESCRIPTION

While the messenger services make it possible to easily deliver chat messages and the like to other users, there are some cases where unwanted messages are received from undesired individuals, leading to cases of stalking and harassment. In order to solve this problem, many messenger services provide a function to set a specific user as a blocked friend so that any unwanted chat message from the blocked friend can be blocked.

Some messenger services provide a function of sending a gift to the other party using a messenger in addition to a function of transmitting a chat message. The function of sending a gift is performed in a way of providing the other party with gift information such as a gift voucher. Since the gift information is not a general chat message, the above-described blocking function for a blocked friend is not applied in many cases.

Therefore, there is a demand for improvement in the methods by which servers provide gift information and by which user terminals show such information in order to prevent stalking and other forms of harassment through the gift-sending function.

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

Singular expressions include plural expressions unless the context clearly indicates otherwise.

In this application, steps described herein can be performed regardless of a listed order, except for a case where they must be performed in the listed order due to a special causal relationship.

It should be further understood that the term “include” or “constituted” used in the application specifies the presence of features, numerals, steps, operations, components, parts mentioned in the specification, or combinations thereof, but do not preclude the presence or addition of one or more other features, numerals, steps, operations, components, parts, or combinations thereof.

Hereinafter, the present disclosure will be described with reference to the accompanying drawings.

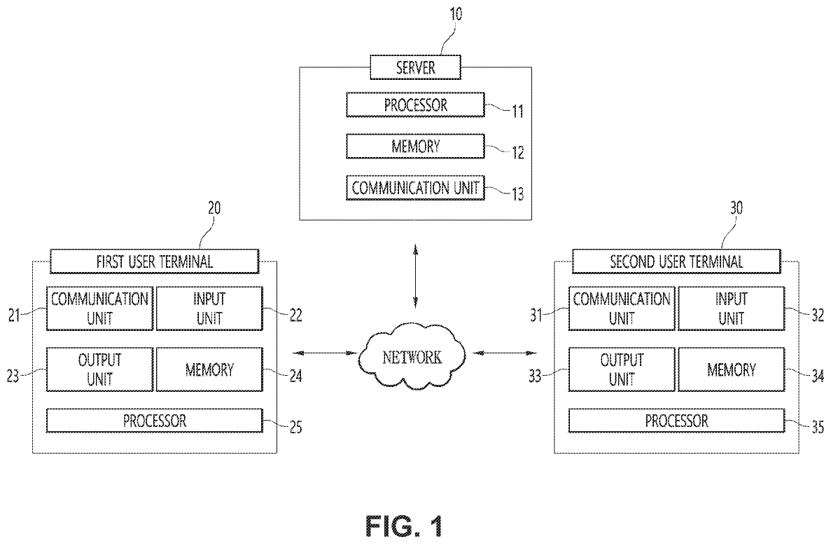

FIG. 1 is a diagram illustrating an example of a network environment according to an embodiment of the present disclosure.

A network environment according to an embodiment of the present disclosure shown in FIG. 1 may include a server 10, a first user terminal 20, and a second user terminal 30.

Communication schemes for a network is not limited. The communication schemes may include not only a communication scheme to utilize a telecommunication network (for example, a mobile communication network, wired Internet, wireless Internet, and a broadcast network), but also a short-range radio communication scheme.

The server 10 may provide a messenger service to a user terminal. The user terminal exemplified by the first user terminal 20 and the second user terminal 30 are devices that use the messenger service provided by the server 10. The server 10 and the user terminal may transmit or receive a signal or data via the network to perform at least one operation related to creation, participation, exit, and message transmission of a chat room.

In the present specification, providing information to a specific user by the server 10 includes providing information on an account of the specific user registered in the service provided by the server 10, and providing information to a user terminal used by the specific user. However, the above-described two types of providing information may not be clearly distinguished.

In the messenger service provided by the server 10, users may establish a friendship with each other. The friendship between users may be established as either one-way friendship or two-way friendship. Establishing a friendship as one-way friendship means that a first user may be a friend of a second user while the second user may not be a friend of the first user. On the other hand, establishing a friendship as two-way friendship means that if the first user is a friend of the second user, the second user is also a friend of the first user.

In some cases, in the messenger service provided by the server 10, a user may set another user as a blocked friend. Accordingly, the user may not receive information such as a message sent or triggered by the blocked friend set by the user. The blocked friend may be set only for a user previously set as a friend, or may be set for a user not previously set as a friend.

For example, it is assumed that the first user sets the second user as his or her blocked friend. If so, the server 10 may not deliver a message from the second user to the first user, or may transmit the message as a blocked message other than a general message. Specifically, the blocked message may be separately displayed as a blocked message and provided to the first user, or may be viewed only when the first user sends a separate request to view the blocked message.

In addition, the server 10 may provide a user terminal with a service for providing, delivering, or mediating a gift between users. This service of providing, delivering, or mediating a gift may be performed based on the above-described messenger service. If the second user sends a gift to the first user, the server 10 may receive from the second user a gift provision request for sending a gift to the first user, and may provide the first user with gift information corresponding to the gift provision request.

This gift or gift information may be implemented in the form of information transmitted over a network. For example, the gift may be a gift voucher that can be exchanged for a specific good or service. In this case, the server 10 may provide the first user terminal 20 with information on the gift voucher. Here, the information on the gift voucher may include at least one of the following: unique identification information on the gift voucher, a barcode, a QR code, information and contents of goods or service to exchange, a user or cancellation available period, and the like.

In another example, the gift may be a delivery coupon for receiving a certain product. In this case, the server 10 may provide the first user terminal 20 with information on the delivery coupon. Here, the information on the delivery coupon may include information and contents of goods to be delivered, a use or cancellation available period, shipping address information, and the like. In some cases, the first user terminal 20 may directly input or change the shipping address information. The gift or gift information is not limited to the above description.

The server 10 may be implemented as a computer device or a plurality of computer devices that provides instructions, codes, file, contents, services, and the like The server 10 may be a server 10 capable of transmitting and receiving information through communication with a user terminal via a network.

The server 10 may include a processor 11, a memory 12, and a communication unit 13.

The processor 11 may control overall operations of the memory 12 and the communication unit 13 to provide a messenger service to a user terminal. The messenger service may be a service that allows a plurality of users to transmit or receive messages to and from each other through a platform provided by the server 10. Here, the messages may include all transmittable data such as texts, photos, videos, voice files, and emoticons.

The memory 12 serves as a storage medium and may store a plurality of application programs running on the server 10, and data and instructions for operating the server 10. In one embodiment, the memory 12 may store applications related to the above-described messenger service and a service for providing, delivering, or mediating a gift.

This memory 12 may be provided in the form of any of various hardware storage devices such as an ROM, an RAM, a flash drive, a hard drive, etc. or may be provided in the form of web storage.

The communication unit 13 may communicate with a user terminal via a network in a wired/wireless manner.

The server 10 of the present disclosure may perform operations as follows: receiving from a second user a gift provision request for sending a gift to a first user; generating gift information corresponding to the gift provision request; determining whether the second user is a blocked friend set by the first user; in response to determining that the second user is a blocked friend, providing the first user with blinded gift information corresponding to the gift information; in response to receiving an unblind request for the blind gift information from the first user, providing partial information to the first user; and in response to receiving a delete request for the blind gift information from the first user, deleting the gift information.

Here, the blinded gift information refers to not-shown partial information out of the gift information, or information partially blinded (which means that actual specific information is not shown but hidden). Hereinafter, for convenience of explanation, both not-shown partial information and information blinded are understood as not being shown. In addition, a state in which partial information is provided without being shown is referred to as a blinded state. Specifically, the partial information not shown in the blinded gift information may be hidden in the first user terminal 20 or may be replaced with another image such as a lock and a question mark.

The partial information not shown in the blinded gift information may be at least one of a gift sender, gift details, and a gift sent time. In some cases, the partial information in the blinded gift information may be partially modified or abstracted. For example, who sends a gift is not specifically indicated, but only part of the information such as a gender, age, or a location (country) is shown. In another example, in the gift details, what kind of goods or service the gift is not specifically shown, but only a type of the gift, such as whether the gift is food or a gift voucher, is shown

Here, when the first user unblocks the blinded gift information, it means requesting that partial information not shown in the blinded gift information be shown. Accordingly, the blinded state of the blinded gift information may be unblinded upon an unblind request for the blinded gift information, and therefore, the blinded state may be changed to an unblinded state.

The first user terminal 20 is a terminal device that receives gift information or blinded gift information from the server 10. The first user terminal 20 may include a communication unit 21, an input unit 22, an output unit 23, a memory 24, and a processor 25.

The communication unit 21 may communicate with the server 10 or other terminals in a wired/wireless manner.

The input unit 22 may receive any of various types of information through a user's manipulation and input behavior. The input unit may be a touch screen module, a keyboard, a mouse, a button, a camera, a stylus, a microphone, and the like.

The first user terminal 20 may receive a user's interaction through the input unit 22. The interaction means that the user operates the input unit 22 to input information reflecting the user's selection or intention to the first user terminal 20. For example, the interaction may be a touch on a touch screen, a click of a mouse, typing of a keyboard, sound input of a microphone, an image capture by a camera, motion recognition by a motion sensor, and the like.

The output unit 23 may output any of various types of information. The output unit 23 may be a display device, a speaker, a vibration generating device, a tactile sensation generating device, and the like. In some cases, the output unit 23 may be a device (e.g., Bluetooth earphone) that is connected to a user terminal through wired or wireless communication (e.g., short-range radio communication such as Bluetooth) to receive and output a signal.

The memory 24 serves as a storage medium and may store a plurality of application programs running on the user terminal, and data and instructions for operating the first user terminal 20. In one embodiment, the memory 12 may store applications related to the above-described messenger service and a service for providing, delivering, or mediating a gift.

This memory may be provided in the form of any of various hardware storage devices such as an ROM, an RAM, a flash drive, a hard drive, etc. or may be provided in the form of web storage.

The processor 25 may control overall operations of the communication unit 21, the input unit 22, the output unit 23, and the memory 24 to execute an application related to the messenger service.

The first user terminal 20 of the present disclosure may perform operations as follows: displaying blind gift information; providing an unblind request interface and a delete request interface for the blind gift information; in response to an unblind request interaction to the unblind request interface, changing the blind gift information to general gift information and displaying the general gift information; and in response to receiving a delete request interaction to the delete request interface, changing the blinded gift information to deleted gift information and displaying the deleted gift information.

The second user terminal 30 is a terminal device that transmits to the server 10 a gift provision request for sending a gift to the first user. If the first user requests deletion of gift information sent by the second user, the second user terminal 30 may receive decline information regarding the gift information from the server 10.

The second user terminal 30 may include a communication unit 31, an input unit 32, an output unit 33, a memory 34, and a processor 35. Each detailed component included in the second user terminal 30 performs substantially the same function as each detailed component included in the first user terminal 20.

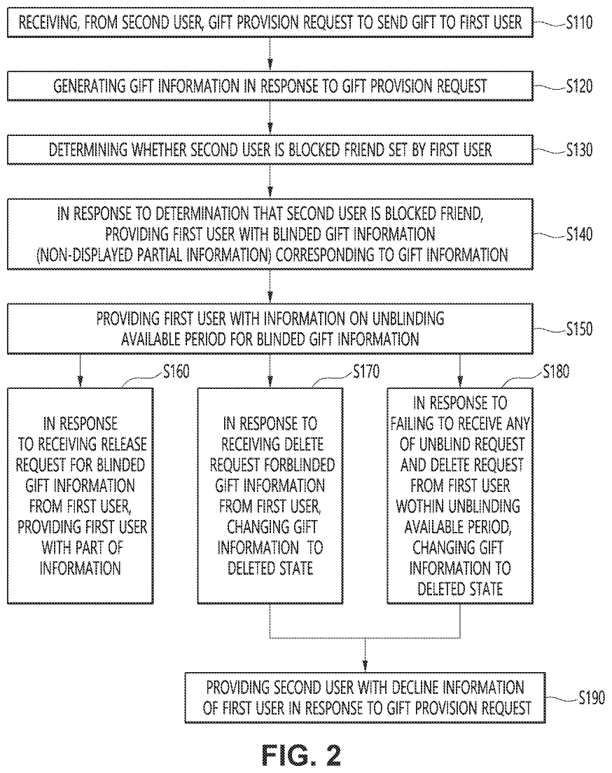

FIG. 2 is a flowchart illustrating a method of providing gift information by the server 10 according to an embodiment of the present disclosure.

In operation S110, the server 10 receives from a second user a gift provision request for sending a gift to a first user. Prior to operation S110, the server 10 may provide the second user with a list of gifts that can be sent to the first user and information on the gifts through the server 10. The second user may select at least one gift from the list of gifts, select a person to receive the gift as the first user, and transmit a gift provision request to the server 10.

The gift provision request may include information on a gift sender (the second user), a gift recipient (the first user), and gift details. The gift details may include a type and contents of goods or services subject to the gift, a gift sent time, a valid period for using or receiving the gift, and information on an address where the gift is to be delivered. The goods or services subject to gifts may be plural. If the gift sender and the gift recipient are the same but there are a plurality of gifts, it may be managed so that the plurality of gifts is included in one gift provision request.

In operation S120, the server 10 generates gift information corresponding to the gift provision request. The server 10 may have a database storing gift information in the server 10 or in a storage accessible by the server 10. The server 10 may generate the gift information corresponding to the gift provision request and store the gift information in the database described above. The server 10 may store the gift information in association with the gift recipient. Therefore, when the first user receives a plurality of gift information, the plurality of gift information may be stored in the database to be subordinate to the first user.

The gift information may include various types of information. Specifically, the gift information may include a gift sender, a gift recipient, gift details, and a status of the gift information. After stored in the database, the gift information may be modified and updated by various factors.

Here, the status of the gift information refers to information indicating how the corresponding gift information is displayed to the first user or whether the first user is able to use the corresponding gift information. In this specification, it will be described the status of the gift information is classified into as a normal state, a blinded state, an unblinded state, a deleted state, or a cancelled state.

At least part of the gift information stored in the database may be provided to the first user at a request from the first user. However, not all the gift information may be provided intact to the first user. As will be described later, when the gift information is in a blinded state, partial information such as a gift sender and gift details may not be provided.

In operation S130, the server 10 determines whether the second user is a blocked friend set by the first user. The server 10 may have or have access to information on blocked friends set by the first user. Using the information on the blocked friends, the server 10 may determine whether the second user is a blocked friend set by the first user. Operation S130 may be performed prior to operation S120 described above.

In operation S140, if the second user is a blocked friend set by the first user, the server 10 provides blinded gift information corresponding to the gift information to the first user. The blinded information means that part of the gift information is not shown. Specifically, the partial information not shown in the blinded gift information may be hidden in the first user terminal 20 or may be replaced with another image such as a lock and a question mark.

The partial information not shown in the blinded gift information may be at least one of a gift sender, gift details, and a gift sent time. Hereinafter, for convenience of explanation, in the blinded gift information, the partial information not shown will be described as information on a gift sender and gift details. Accordingly, due to the gift information, the first user may not be exposed to blocked friends and gift information sent by the blocked friends

In some cases, the partial information in the blinded gift information may be partially modified or abstracted. For example, who sends a gift is not specifically indicated, but only part of the information such as a gender, age, or a location (country) is shown. In another example, in the gift details, what kind of goods or service the gift is not specifically shown, but only a type of the gift, such as whether the gift is food or a gift voucher, is shown

Although not shown in FIG. 2, when the second user is not a blocked friend set by the first user, the server 10 provides the first user with general gift information corresponding to the gift information. Unlike the blinded gift information, the general gift information means that partial information described above is also shown.

The first user may easily distinguish the blinded gift information and the general gift information by comparing whether part of the gift information provided is hidden or replaced with another image such as a lock or a question mark and whether partial information described above is also shown.

In operation S141, the server 10 provides the first user with information on an unblinding available period for blinded gift information. Operation S141 may be performed simultaneously with operation S140. In this case, the server 10 may provide the blinded gift information and the unblinding available period together to the first user. In addition, the first user terminal 20 may display the blinded gift information and the unblinding available period together.

The unblinding available period refers to a period during which the first user can unblind the blinded state of the blinded gift information. As will be described later, when the first user does not request unblinding the blinded gift information within the unblinding available period, the blinded gift information may not be available to be unblinded any longer and may be changed to a cancelled state.

The unblinding available period may be set based on a time or date when the gift information is created. For example, the unblinding available period may be set to be within 7 days after the date the gift information is generated.

After providing the blinded gift information to the first user in operation S140, the server 10 may provide an information check interface, an unblind request interface, and a delete request interface regarding the blinded gift information.

The information check interface is an interface through which the first user can request the server 10 to check unshown partial information out of the blinded gift information in a state in which the blinded gift information remains in a blinded state.

The unblind request interface is an interface through which the first user can request the server 10 to unblind the blinded state of the blinded gift information so as to change the blinded state to the unblinded state, and to check partial information shown. In this case, the gift information may be usable by the first user.

The delete request interface means that the first user request the server 10 to change the blinded state of the blinded gift information to a deleted state. In this case, the gift information may no longer be usable by the first user.

The server 10 may receive a request from the first user to check partial information not shown in the blinded gift information. The request to check partial information out of the blinded gift information may be made within an unblinding available period of the blinded gift information. Also, the request to check the partial information out of the blinded gift information may be made before a request to unblind or delete the blinded gift information is received. In this case, operation S150 is performed.

In operation S150, the server 10 receives a request to provide the partial information from the first user, and provides the first user with the partial information requested. As described above, when the partial information not shown in the blind display information is a gift sender and gift details, the server 10 may provide the gift sender and the gift details to the first user in operation S150. Such information provided may be separately shown in the first user terminal 20, or may be shown in a way of changing the blinded gift information already shown to general gift information. The first user may check the partial information not shown in operation S150 and then determine a follow-up action, such as whether to unblind or delete the blinded gift information or whether to leave the blinded gift information until the unblinding available period elapses.

Even after the server 10 provides the partial information to the first user in response to a request to provide the partial information, the blinded gift information may still remain in the blinded state. Specifically, when the first user terminal 20 requests to provide the partial information, the partial information may be shown in a separate area such as a pop-up window. Also, after displaying of the partial information ends, the gift information may still be shown in a blinded state to the first user terminal 20. Since the blinded gift information still remains in the blinded state, the first user is able to request unblinding or deleting of the blinded gift information within the unblinding available period.

FIG. 2 shows a case where operation S160, S170 or S180 is performed after operation S150, but operation S150 may be omitted in some cases. In this case, a user decides a follow-up action for the blinded gift information, without checking the partial information not shown in the blinded gift information.

The server 10 may receive an unblind request for the blinded gift information from the first user. The unblind request may be made within the unblinding available period for the blinded gift information. In addition, if a delete request for the blinded gift information is already received, the unblind request is not possible to be made. When the server 10 receives the unblind request as described above, operation S160 is performed.

In operation S160, the server 10 receives an unblind request for the blinded gift information from the first user, and provides the first user with the above-described partial information. Here, the unblind request for the blinded gift information may be input by the first user to the above-described unblind request interface.

As described above, when the partial information not shown in the blind display information is a gift sender and gift details, the server 10 may provide the first user with the gift sender and the gift details in operation S160. Such information provided may be separately displayed in the first user terminal 20, or may be displayed in a way of changing the blinded gift information already displayed to general gift information.

After receiving an unblind request for the blinded gift information from the first user, the server 10 may change the status of the blinded gift information to an unblinded state. The server 10 may update the database based on the change of the state. Accordingly, the first user may be in a state able to use the corresponding gift information. This unblinded state may be the same as a normal state.

The server 10 may receive a delete request for the blinded gift information from the first user. The delete request may be made within the unblinding available period for the blinded gift information. In addition, if the unblind request for the blinded gift information is already received, the delete request is not possible to be received. When the server 10 receives the delete request as described above, operation S170 is performed.

In operation S170, the server 10 receives a delete request for the blinded gift information from the first user, and changes gift information corresponding to the blinded gift information to a deleted state. Specifically, the blinded gift information is changed from the blinded state to the deleted state. Due this change, what is displayed as blinded gift information in the first user terminal 20 may be changed to and displayed as deleted gift information. The server 10 may update the database based on the change of the blinded gift information from the blinded state to the deleted state.

The server 10 may not receive both an unblind request and a delete request from the first user within the unblinding available period for the blinded gift information. In this case, operation S180 is performed.

In operation S180, the server 10 changes the gift information corresponding to the blinded gift information to a cancelled state. Specifically, the blinded gift information is changed from the blinded state to the cancelled state. Due to this change, what is displayed as blinded gift information in the first user terminal 20 may be changed to and displayed as cancelled gift information. The server 10 may update the database based on the change of the blinded gift information from the blinded state to the cancelled state.

While the deleted state is implemented when the first user makes a delete request, the cancelled state is implemented when the first user does not make any request to the server 10 within the unblinding available period. Accordingly, the deleted state is caused by the first user's active request, and it is possible for the first user to set a time of change to the deleted state. However, the cancelled state is not caused by the first user's active request, and it is not possible for the first user to set a time of change to the cancelled state, but a time of the change may be determined in conjunction with the unblinding available period.

When the gift information is in a deleted or cancelled state, the first user is not able to use a corresponding gift any longer. In some cases, the gift information in a deleted or cancelled state may be stored as an available gift for the first user and displayed in the unavailable gift box in the first user terminal 20. However, in some cases, even in this unavailable gift box, the gift information in a deleted or cancelled state may be hidden (in the terminal).

Whether or not the gift information is displayed in the unavailable gift box may be differently set depending on a status of the gift information. For example, when the gift information is in a deleted state, the gift information may not be immediately displayed in the first user's unavailable gift box. When the gift information is in a cancelled state, the gift information may be displayed in the first user's unavailable gift box and may be then hidden upon the first user's hide request. As such, depending on the status of the gift information, it may be set whether the gift information is displayed or hidden in the unavailable gift box of the first user.

When the server 10 changes the gift information to a deleted state in operations S170 and S180, operation S190 is performed. In operation S190, the server 10 provides the second user with decline information of the first user in response to the gift provision request. The decline information does not indicate whether the first user has blocked the second user, whether a blind gift is unlocked, deleted, or cancelled, or the like. However, the decline information may only indicate that the first user declines the gift and returns the gift to the second user. Therefore, based on the decline information provided to the second user, it is not possible to know whether the second user is a blocked friend set by the first user, whether the gift information was in a blinded state and then deleted, and whether the first user has declined general gift information. Then, if the second user has paid for the gift, the server 10 may additionally perform an operation of canceling the payment.

In some cases, when the gift provision request in operation S110 includes information on a shipping address of the gift, the decline information described in operation S190 may include information on cancellation due to the first user's failing to input the shipping address information for the gift provision request.

When the server 10 provides the gift information in the above-described method, information on a blocked friend and a gift presented by the blocked friend is not exposed to the first user, so that the first user may be protected from stalking or the like. In addition, even if the gift information is deleted, the second user never knows that he or she is a blocked friend set by the first user. Accordingly, the second user is not able to know whether the gift information is in a blinded state and then deleted, and thus, it is possible to avoid unnecessary misunderstanding, offense, or hurt.

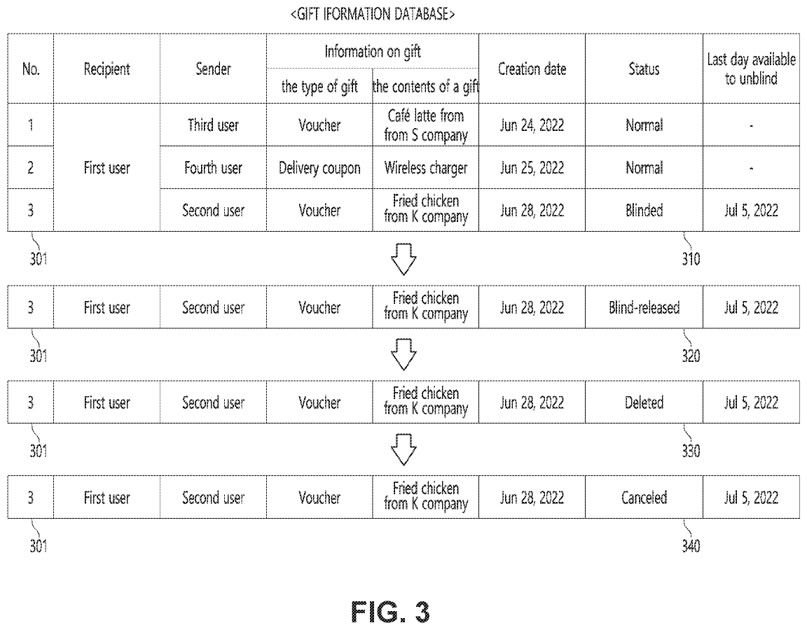

FIG. 3 is a diagram for explaining a database generated while the server 10 according to an embodiment of the present disclosure performs the method of providing gift information, which is described with reference to FIG. 2.

In operation S120, the server 10 generates gift information corresponding to a gift provision request. Referring to FIG. 3, it can be seen that gift information 301 is generated in response to the gift provision request from the second user to send a gift to the first user. It can be seen that first, second, and third gift information is stored so as to be subordinate to a first user, which is a gift recipient.

A status of the gift information in the database may be set and stored in various ways. As for the third gift information 301, the third gift information 301 may be initially set to a blinded state 310, and may be changed to an unblinded state 320 when operation S160 is performed later.

In some cases, the third gift information 301 may be initially set to a blinded state 310, and may be changed to a deleted state 330 when operation S170 is performed later.

Also, in some cases, the third gift information 301 may be initially set to a blinded state 310, and may be changed to a cancelled state 340 when operation S180 is performed later.

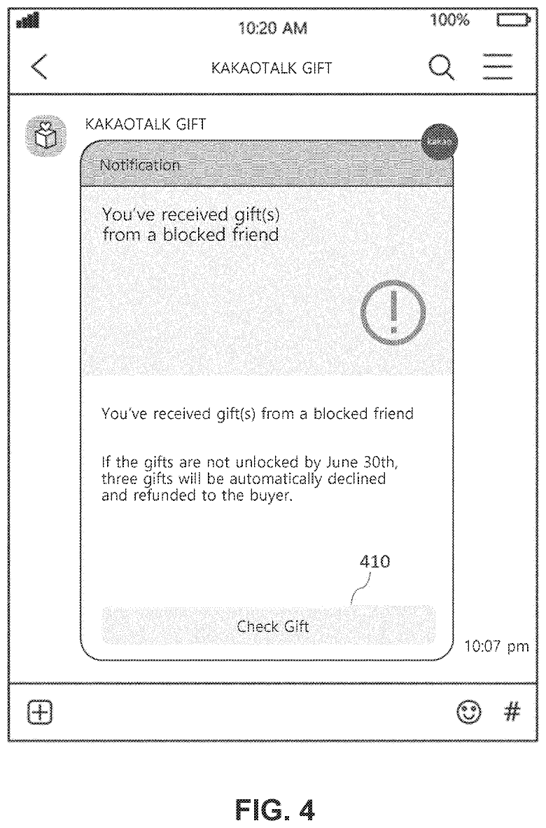

FIGS. 4 to 9 illustrate examples of screens displayed in a first user terminal 20 while the server 10 performs the method of providing gift information, which is described with reference to FIG. 2.

Referring to FIG. 4, an embodiment in which the first user terminal 20 displays blinded gift information will be described.

FIG. 4 may be a screen of the first user terminal 20 as operation S140 is performed. In operation S140, the server 10 provides blinded gift information corresponding to gift information to the first user. As shown in FIG. 4, blinded gift information may be provided in the form of a message.

Non-shown partial information in the blinded gift information may be information on a gift sender and gift details. Referring to FIG. 4, the blinded gift information only indicates that “My blocked friend” sent a gift, but information on the gift sender and the gift details may not be shown.

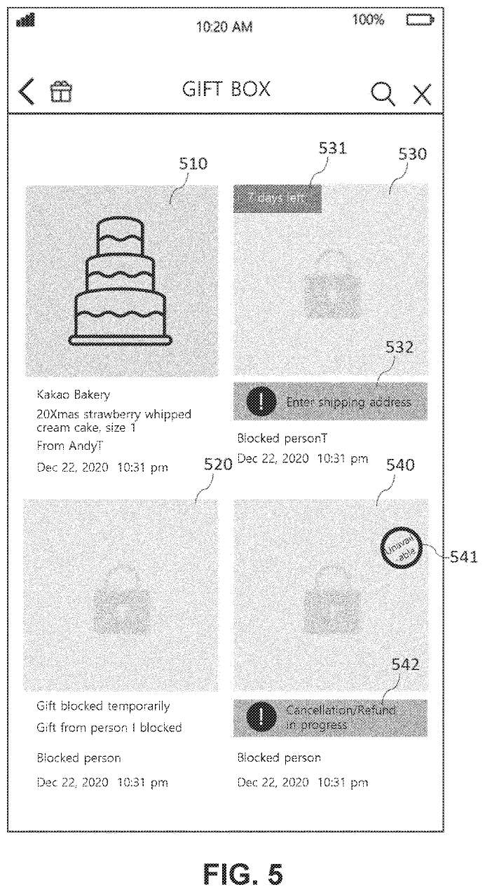

Referring to FIG. 5, another embodiment in which the first user terminal 20 displays blinded gift information will be described.

FIG. 5 may be a screen of the first user terminal 20 as operation S140 is performed. In operation S140, the server 10 provides blinded gift information corresponding to gift information to the first user. As shown in FIG. 5, the blinded gift information may be provided and displayed on a gift box screen displaying at least one gift information received by the first user. This gift box screen may be moved and displayed through a gift check interface 410 of FIG. 4.

As for gift information 510, it can be seen that the gift information 510 is a general gift sent by a user who is not a blocked friend set by the first user, and both the gift sender and gift details are shown.

As for gift information 520, it can be seen that the gift information 520 is blinded gift information, and a gift sender and gift details are not shown. Specifically, it can be seen that the gift sender is shown as “blocked person” and the gift details are shown as a lock image.

As for gift information 530, it can be seen that the gift information 530 is blinded gift information, and a gift sender and gift details are not shown. In addition, it can be seen that the unblinding available period 531 is displayed. In addition, it can be seen that the corresponding gift information 530 is a gift for which a shipping address must be input, and a shipping address information input interface 532 for inputting a shipping address is displayed.

As for the gift information 530, when the gift information 530 is a deleted or cancelled state, decline information indicating that the first user has declined the gift may be provided to the gift sender of the gift, and in some cases, cancellation information due to a failure to input shipping address information may be provided.

Gift information 540 is blinded gift information and indicates that a state thereof has changed to a deleted or cancelled state upon a delete request from the first user after an elapse of an unblinding available period. It can be seen that information 541 and 542 indicating that the gift information 540 is in a deleted state or a canceled state is displayed.

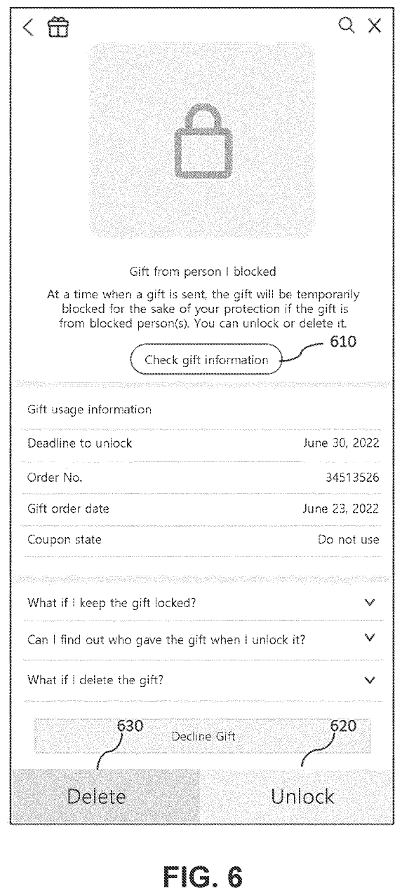

Referring to FIG. 6, an embodiment in which the first user terminal 20 displays detailed information of blinded gift information will be described. FIG. 6 illustrates a screen displayed when an interaction to the gift information 520 of FIG. 5 is input in the first user terminal 20.

FIG. 6 may be a screen of the first user terminal 20 as operation S140 is performed. Referring to FIG. 6, the unblinding available period, order number, gift order date, coupon state, etc. are displayed regarding the gift information 520, but the gift sender and gift information is not shown intact and but blinded. Specifically, referring to FIG. 6, it can be seen that the gift sender is displayed as “person I blocked”, “gift details” is displayed as a locked image, and a product name of the gift is replaced with “gift from person I blocked”.

Referring to FIG. 6, it can be seen that an information check interface 610, an unblind request interface 620, and a delete request interface 630 for corresponding blinded gift information are displayed.

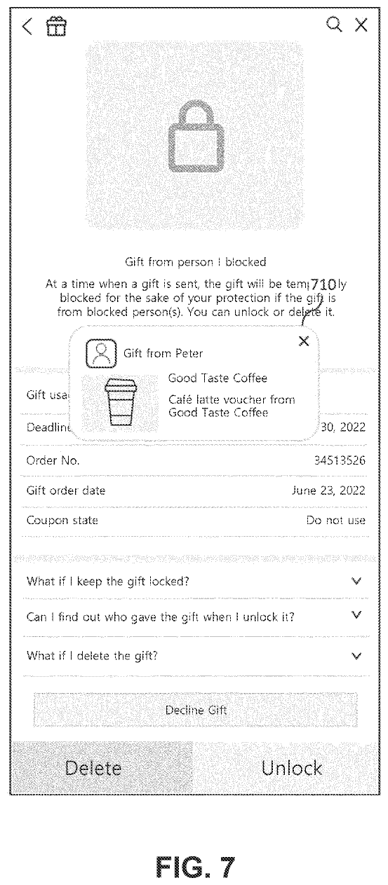

Referring to FIG. 7, an embodiment of displaying partial information after the first user terminal 20 requests provision of partial information not shown in blinded gift information will be described. FIG. 7 illustrates a screen displayed when an interaction to the information check interface 610 of FIG. 6 is input from the first user terminal 20.

FIG. 7 may be a screen of the first user terminal 20 as operation S150 is performed. In operation S150, the server 10 receives a request for provision of partial information from the first user, and provides the first user with partial information 710. Referring to FIG. 7, it can be seen that partial information 710 not shown in the blinded gift information of FIG. 6 is displayed. Specifically, referring to FIG. 7, it can be seen that the gift sender and gift details in the blinded gift information are displayed.

As shown in FIG. 7, even if non-shown partial information 710 ends up appearing upon a blind information check request from the first user, the status of the blinded gift information may still remain in a blinded state.

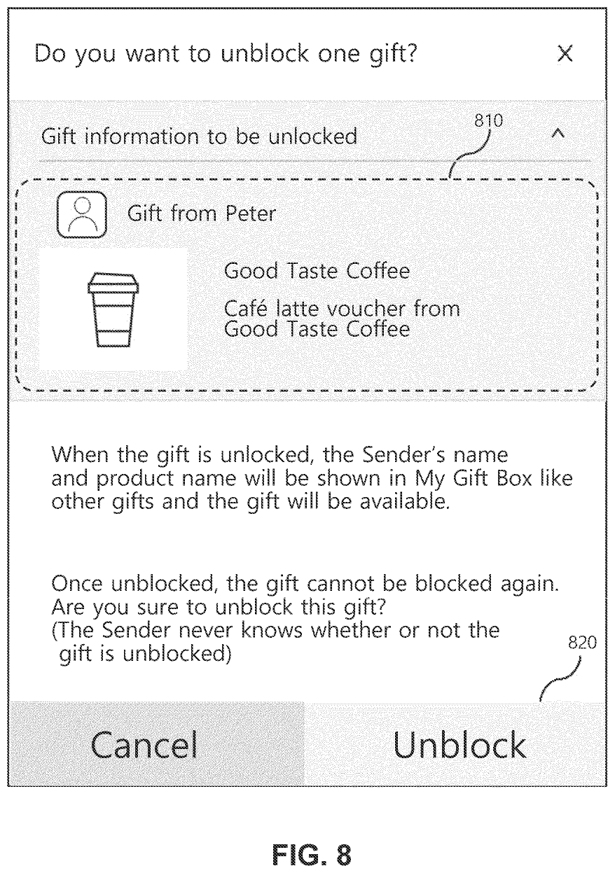

Referring to FIG. 8, an embodiment of a process in which the first user terminal 20 requests unblinding of blinded gift information will be described. FIG. 8 illustrates a screen displayed when an interaction to the unblind request interface 620 of FIG. 6 is input in the first user terminal 20.

FIG. 8 may be a screen of the first user terminal 20 to perform operation S160. In operation S160, the server 10 receives an unblind request for blinded gift information from the first user. Referring to FIG. 8, the first user terminal 20 may receive an interaction to an unblind request interface 820.

Referring to FIG. 8, it can be seen that information 810 indicating a gift sender and gift details in blinded gift information are displayed. The information 810 may be displayed when the gift sender and gift details in the blinded gift information are already provided to the first user terminal 20 after operation S150 is performed.

If operation S150 is not performed, the information 810 indicating the gift sender and gift details in the blinded gift information may not be displayed on the screen of FIG. 8. In this case, the first user may make an unblind request for the corresponding blinded gift information, without checking the gift sender and gift details in the blinded gift information.

According to the method described above, when the server 10 receives an unblind request for the blinded gift information, the server 10 changes the status of the blinded gift information from a blinded state to an unblinded state. Then, in the first user terminal 20, the blinded gift information is changed to and displayed as general gift information. Being displayed as the general gift information means that the gift sender and gift details are all displayed as shown in the gift information 510 of FIG. 5.

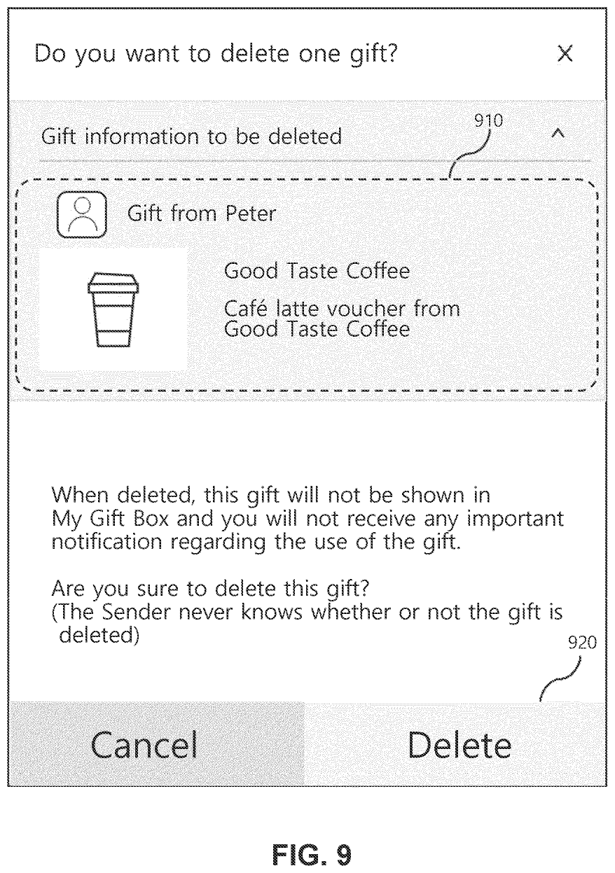

Referring to FIG. 9, an embodiment of a process in which the first user terminal 20 requests deletion of blinded gift information will be described. FIG. 9 illustrates a screen displayed when an interaction to the delete request interface 630 of FIG. 6 is input in the first user terminal 20.

FIG. 9 may be a screen of the first user terminal 20 to perform operation S170. In operation S170, the server 10 receives a delete request for blinded gift information from the first user. Referring to FIG. 9, the first user terminal 20 may receive an interaction to the delete request interface 920.

Referring to FIG. 9, it can be seen that information 910 indicating a gift sender and gift details in the blinded gift information are displayed. The information 910 may be displayed when the gift sender and gift details in the blinded gift information are already provided to the first user terminal 20 after operation S150 is performed.

If operation S150 is not performed, the information 910 indicating the gift sender and gift details in the blinded gift information may not be displayed on the screen of FIG. 9. In this case, the first user may request deletion of the blinded gift information, without checking the gift sender and gift details in the blinded gift information.

According to the method described above, when the server 10 receives a request for deletion of the blinded gift information, the server 10 changes a status of the corresponding blinded gift information from a blinded state to a deleted state. Then, in the first user terminal 20, the blinded gift information is changed to and displayed as deleted gift information. Being displayed as the deleted gift information means that information 541 and 542 indicating that the gift information is in a deleted state is displayed as in the gift information 540 of FIG. 5.

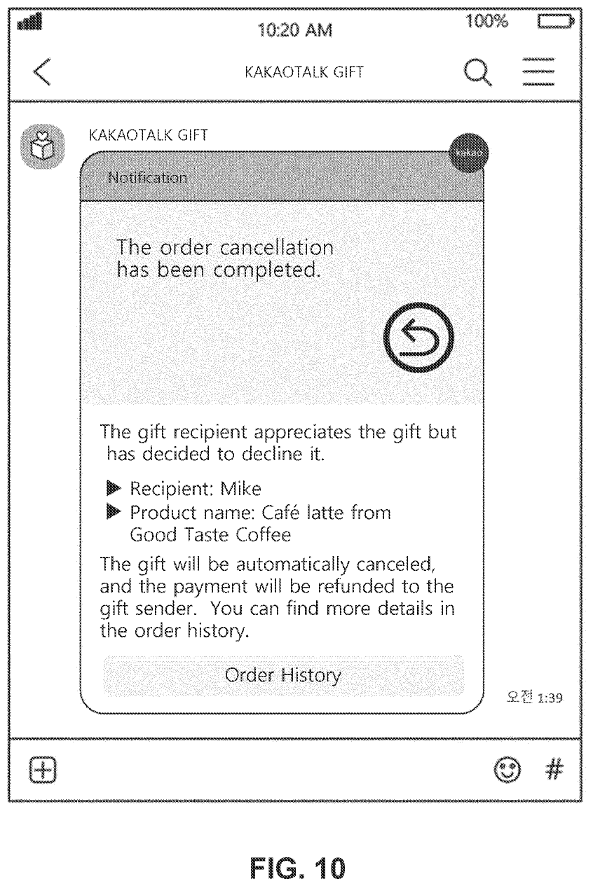

FIG. 10 illustrates an example of a screen displayed on a second user terminal while the server 10 performs the method of providing gift information, which is described with reference to FIG. 2.

Referring to FIG. 10, an embodiment in which the second user terminal displays decline information will be described.

FIG. 10 may be a screen of the second user terminal 30 as operation S190 is performed. In operation S190, the server 10 provides the second user with decline information of the first user in response to the gift provision request. As shown in FIG. 10, the second user terminal 30 may display decline information, indicating that the first user has declined the gift information, in the form of a message. Based on the decline information provided to the second user, it is not possible to know whether the second user is a blocked friend set by the first user, whether the gift information was in a blinded state and then deleted, and whether the first user has declined general gift information.

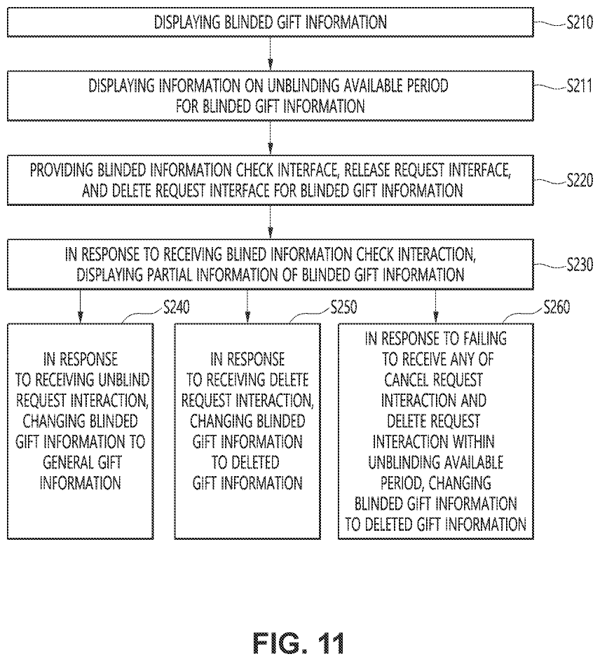

FIG. 11 is a flowchart illustrating a method of displaying gift information by a user terminal according to an embodiment of the present disclosure. A user terminal performing the method described herein may be the first user terminal 20 described above.

The method of displaying gift information by the user terminal corresponds to the method of providing gift information by the server 10, which is described above with reference to FIG. 2. Therefore, for convenience of explanation, in describing the method of displaying gift information, some of the contents overlapping with those already described above will be omitted.

In operation S210, a user terminal displays blinded gift information. In the blinded gift information, part of gift information is not shown. Here, the partial information not shown may be a gift sender and gift information in the gift information.

In operation S211, the user terminal displays information on an unblinding available period of the blinded gift information. Operation S211 may be performed simultaneously with operation S210. In this case, the user terminal may display the blinded gift information and the unblinding available period together. This is described in details with reference to FIGS. 4 to 6.

In operation S220, the user terminal provides a blind information check interface, an unblind request interface, and a delete request interface for the blinded gift information. This is described in details with reference to FIG. 6.

In operation S230, the user terminal displays partial information in the blinded gift information in response to receiving a blind information check interaction. Although the partial information in the blinded gift information is displayed, the blinded gift information remains in a blinded state. This is described in details with reference to FIG. 7.

In operation S240, when the user terminal receives an unblind request interaction, the blinded gift information is changed to and displayed as general gift information. This means that the blinded gift information 520 of FIG. 5 is changed to and displayed in the same form of that of the general gift information 510.

In operation S250, when the user terminal receives a delete request interaction, the blinded gift information is changed to and displayed as deleted gift information. This means that the blinded gift information 520 of FIG. 5 is changed to and displayed in the same form of the deleted gift information 540.

In operation S260, when the user terminal does not receive neither the unblind request interaction nor delete request interaction within an unblinding available period, the blinded gift information is changed to and displayed as cancelled gift information. This means that the blinded gift information 520 of FIG. 5 is changed and displayed in the same form of the cancelled gift information 540.

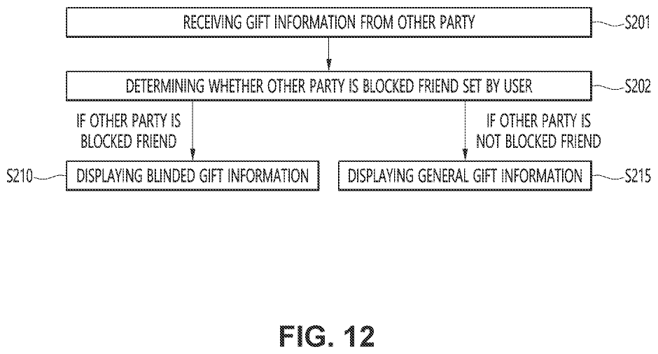

FIG. 12 is a flowchart illustrating a method of displaying gift information by a user terminal according to another embodiment of the present disclosure. A user terminal performing the method described herein may be the first user terminal 20 described above.

In operation S201, before the user terminal 20 displays blinded gift information, the user terminal 20 receives gift information sent by the other party. Here, the gift information sent by the other party may not be divided into blinded gift information and general gift information.

In operation S202, the user terminal 20 determines whether the other party is a blocked friend set by the user. To this end, the user terminal 20 may use blocked-friend information of the user, which is stored in or accessible by the user terminal 20.

If the other party is a blocked friend, the gift information sent by the other party is set as blinded gift information and operation S210 described above is performed.

If the other party is not a blocked friend, operation S215 of setting the gift information sent by the other party as general gift information and displaying the general gift information is performed.

When the user terminal displays gift information according to the above-described method, information on a blocked friend and a gift presented by the blocked friend is not exposed to the first user, so that the first user may be protected from stalking or the like.

According to the present disclosure, in the method of providing a user with gift information sent by a blocked friend set by the user, part of the gift information is blinded, so that unwanted information is not exposed to the user.

In addition, according to the present disclosure, a user who receives a gift is also provided with the right to unblind a blinded state of gift information that is partially blinded, so that the user can check the information by his or her own choice and decide whether to receive or decline the gift.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.

What is claimed is:

1. A method for providing gift information by a server, the method comprising:
receiving from a second user a gift provision request for sending a gift to a first user;
generating gift information in response to the gift provision request;
determining whether the second user is a blocked friend set by the first user;
in response to determining that the second user is the blocked friend, providing the first user with blinded gift information corresponding to the gift information, wherein partial information out of the gift information is not shown in the blinded gift information; and
in response to receiving an unblind request for the blinded gift information from the first user, providing the first user with the partial information out of the gift information.

2. The method of claim 1, further comprising:
in response to receiving a delete request for the blinded gift information from the first user, changing the gift information to a deleted state.

3. The method of claim 1, further comprising:
providing the first user with information on an unblinding available period for the blinded gift information; and
in response to failing to receive the unblind request and the delete request from the first user within the unblinding available period, changing the gift information to a cancelled state.

4. The method of claim 1, wherein the partial information out of the gift information comprises at least one of sender information and gift details in the gift information.

5. The method of claim 1, further comprising:
in response to determining that the second user is the blocked friend, setting state information on the gift information to a blinded state; and
in response to receiving an unblind request for the blinded gift information from the first user, changing the state information from the blinded state to an unblinded state.

6. The method of claim 5, further comprising:
providing information on an unblinding available period for the blinded gift information; and
in response to receiving a delete request for the blinded gift information from the first user or failing to receive any of an unblind request and a delete request from the first user within the unblinding available period, changing the state information from the blinded state to the deleted state.

7. The method of claim 5, further comprising:
in response to receiving a request for the state information from the first user, providing the state information to the first user.

8. The method of claim 1, further comprising:
in response to receiving a request to provide the partial information out of the gift information from the first user before receiving the unblind request or the delete request, providing the first user with the partial information out of the gift information.

9. The method of claim 8, further comprising:
in response to determining that the second user is the blocked friend, setting state information on the gift information to a blinded state;
in response to receiving from the first user a request to provide the partial information out of the gift information; and
in response to receiving an unblind request for the blinded gift information from the first user, changing the state information from the blinded state to an unblinded state.

10. The method of claim 1, further comprising:
in response to receiving a request to delete the blinded gift information from the first user, providing the second user with decline information of the first user in response to the gift provision request.

11. The method of claim 1, further comprising:
providing information on an unblinding available period for the blinded gift information, and
in response to receiving the unblind request and the delete request from the first user within the unblinding available period, providing the second user with decline information of the first user for the gift provision request.

12. The method of claim 1, wherein:
the gift provision request comprises information on a shipping address of the gift, and
the method further comprises, in response to receiving a request to delete the blinded gift information from the first user, providing the second user with cancellation information due to the first user's failing to input shipping address information for the gift provision request.

13. A non-transitory computer readable recording medium storing instructions, when executed by one or more processors, configured to perform the method of claim 1.

14. A server for providing gift information, the server comprising:
a memory storing instructions; and
a processor configured to execute the instructions to:
receive from the second user a gift provision request for sending a gift to the first user;
generate gift information in response to the gift provision request;
determine whether the second user is a blocked friend set by the first user;
in response to determining that the second user is the blocked friend, provide the first user with blinded gift information corresponding to the gift information, wherein partial information out of the gift information is not shown in the blinded gift information; and
in response to receiving an unblind request for the blinded gift information from the first user, provide the first user with the partial information out of the gift information.

15. A method for displaying gift information by a user terminal, the method comprising:
displaying blinded gift information, wherein partial information out of the gift information is not shown in the blinded gift information;
providing an unblind request interface and a delete request interface for the blinded gift information; and
in response to receiving an unblind request interaction to the unblind request interface, changing the blinded gift information to general gift information, wherein the partial information out of the generation information is additionally displayed in the blinded gift information.

16. The method of claim 15, further comprising:
in response to receiving a delete request interaction to the delete request interface, changing the blinded gift information to deleted gift information.

17. The method of claim 15, further comprising:
displaying information on an unblinding available period for the blinded gift information; and
in response to failing to receiving the unblind request interaction and the delete request interaction within the unblinding available period, changing the blinded gift information to deleted gift information.

18. The method of claim 15, wherein the partial information out of the gift information comprises at least one of sender information and gift details in the gift information.

19. The method of claim 15, further comprising:
providing a blind information check interface for the blinded gift information; and
in response to receiving a blind information check interaction to the blind information check interface, displaying partial information out of the blinded gift information while maintaining the blinded gift information in a blinded state.

20. The method of claim 15, further comprising:
receiving gift information sent by other party;
determining whether the other party is a blocked friend set by the user;
in response to determining that the other party is the blocked friend, setting the gift information as the blinded gift information; and
in response to determining that the other party is not the blocked friend, setting the gift information as the general gift information.
